(19) United States
(12) Patent Application Publication
(10) Pub. No.: US 2006/0082160 A1
(43) Pub. Date: Apr. 20, 2006

(54) Wind powered generator platform

(76) Inventor: Tommy Lewis Lee, East Grand Rapids, MI (US)

Correspondence Address: CHRISTOPHER D. HARRINGTON;HARRINGTON LAW OFFICES, 447 ADA DRIVE SE, ADA, MI, 49301, US

(21) Appl. No.: 10/965,033

(22) Filed: Oct. 14, 2004

(51) Int. Cl. F03D 9/00; H02P 9/04

(52) U.S. Cl. 290/55

(57) ABSTRACT

A wind powered generation platform in accordance with the present invention provides for remote placement of wind generation systems in a body of water. A platform for such use includes a base portion, a control portion, a stabilizing portion, a power generation portion and a power link portion. Management of the platform is automated and independent and platforms may be organized into aquatic wind farms without the necessity of having to provide manpower to supervise operations. Another embodiment of the present invention provides for the generation of hydrogen in remote locations, which may be harvested on a periodic basis.

### FIELD OF THE INVENTION

The field of the invention is wind powered generating systems. More particularly, the field of the invention relates to a platform for the deployment of wind powered generating system.

### BACKGROUND OF THE INVENTION

Wind powered generating systems have been used for centuries, dating back to times when windmills provided raw mechanical power for the milling of grains or for pumping water. In more recent times, however, wind power has been used to generate electricity, especially in view of shortages in energy supplies of various kinds over the last several decades. The fact remains that most consumable energy is based upon nonrenewable resources such as oil, gas, coal, and wood, for example. Other energy sources such as nuclear power may be considered renewable, or in the alternative, virtually inexhaustible, however these are fraught with tremendous problems insofar as waste disposal and environmental considerations.

Into this void of acceptable renewable energy sources comes wind power. Commencing in earnest in the 1970s, “wind farms” were put into place to leverage advantageous locations where weather patterns favored consistently strong winds. One such wind farm is located near Palm Springs, Calif. and has been in substantially constant use since its installation. The output from such wind farms is directed to the “grid” that transports electricity from one location to another. Many times there arises conflicts in the siting of wind farms, which some communities have fought as being unsightly. Thus locations tend to be remote, but the need for a connection to the grid remains. This situation has inhibited the installation of wind farms and has retarded their proliferation as a viable alternative to other energy sources.

As it turns out, some remote locations for wind-powered generation are naturally blessed with consistent and vigorous wind patterns. The problem has been the ability to harvest wind resources in such areas with minimal need for human intervention, while providing a means for transporting the electricity generated to a location where it can be used.

There are also locations where traditional energy delivery systems are not feasible. For instance, locations near coastlines that are distant from the grid access. Another example would be island locations. Sometimes these locations may be limited by factors other than the geographical circumstance, such as locations in third world nations or depressed portions of otherwise moderately vital countries. The lack of a reliable energy resource, much less one that is essentially renewable, certainly impacts the living standards of such communities and retards their development commercially and socially.

There are other applications where access to a reliable power source would be advantageous. Offshore drilling platforms or scientific research stations could benefit from an energy source that is both reliable and which has reduced management requirements. Resorts that desire to promote remote destinations such as island adventures or exclusive coastal retreats could be benefited by electrical service that is cost-effective and reasonably dependable.

One trait common to many of the prior art wind platforms is the fact they are stationary. Some, like the wind farms described above, are built inland and have bases that are anchored or fixed to the ground. The orientation of the platform to wind direction is not a sensitive parameter in this instance since the generator is able to rotate to meet the wind as conditions warrant. While wind farms have supplied a portion of the answer to the search for a renewable energy resource, wind power has not been exploited in ways that could benefit the applications described above.

### SUMMARY OF THE INVENTION

A novel wind generator platform comprises a base for floating a wind power generation station near coastal areas, as well as on high seas environments. The wind generator platform of the present invention includes a stabilizing portion (keel), a control portion (system manager), a power generation portion (turbine), a tether portion, and a power link portion. Further, the stabilizing portion in one embodiment includes a keel that extends below the exposed portion of the base and which has sufficient depth and weight to keep the wind generator platform in a relatively constant position. The power generation portion further includes turbine generators which are mounted so as to be able to rotate to allow the turbine blades to address the direction of the prevailing winds at all times.

In one embodiment, the wind generator platform's stabilizing portion is a connection made directly to an anchoring device that retains the platform in substantially the same location for long periods of time. The anchoring device may be lifted and moved to allow the platform to be relocated.

In yet another embodiment of the present invention, the stabilizing portion is comprised of at least one drive unit that is capable of propelling the platform. The drive unit is controlled and can steer the platform to a desired location or retain the platform at a desired location.

The wind generator platform of the present invention is able to produce electrical power via the action of the prevailing winds on at least one turbine. Through a control system, the power generated is directed for transmission to end users by means of a power link portion and/or may be directed for onboard consumption for control and stabilization purposes.

### BRIEF DESCRIPTION OF THE DRAWINGS

FIG. 1 is a side elevational view of a wind generator platform of the present invention.

FIG. 2 is a top view of an alternate embodiment of a wind generator platform of the present invention.

### DETAILED DESCRIPTION OF THE PREFERRED EMBODIMENTS

A wind generator system according to the present invention comprises a highly versatile platform that is used in a marine environment. Specifically, platforms of the present invention may be deployed near coastal areas, near islands, or if desired, an alternate embodiment may be deployed in open waters of virtually any type. Each such platform comprises an individual wind powered generator station, which, as will be seen and understood below, can be linked with other wind powered generator stations to form an aquatic wind farm somewhat analogous to those that are land-based. The present invention, however, overcomes the problems associated with the control and management of an aquatic wind farm, which has heretofore inhibited the development of such systems.

The impetus for the present invention arises from the need that arises from time to time for reliable power sources in remote locations. Applications of this type may range from short-term construction or exploration projects such as oil drilling or coastal mining operations, or longer-term applications such as resorts or native communities. These situations are typified by the fact that the “grid” from which conventional electrical service is supplied is either remote or non-existent. The need for point-source power generation has been a long-standing problem, which heretofore has been solved through reliance on expensive power generation secondary to diesel or natural gas sources.

While wind power has been used for power generation in some remote locations. It is applicant's belief that these instances have been largely used as incidental power sources. The electrical power generated being used to augment non-wind powered sources or where the wind power is used only intermittently. With the present invention, the usage of wind-generated power is more usable and less likely to need augmentation or to be scheduled for intermittent consumption.

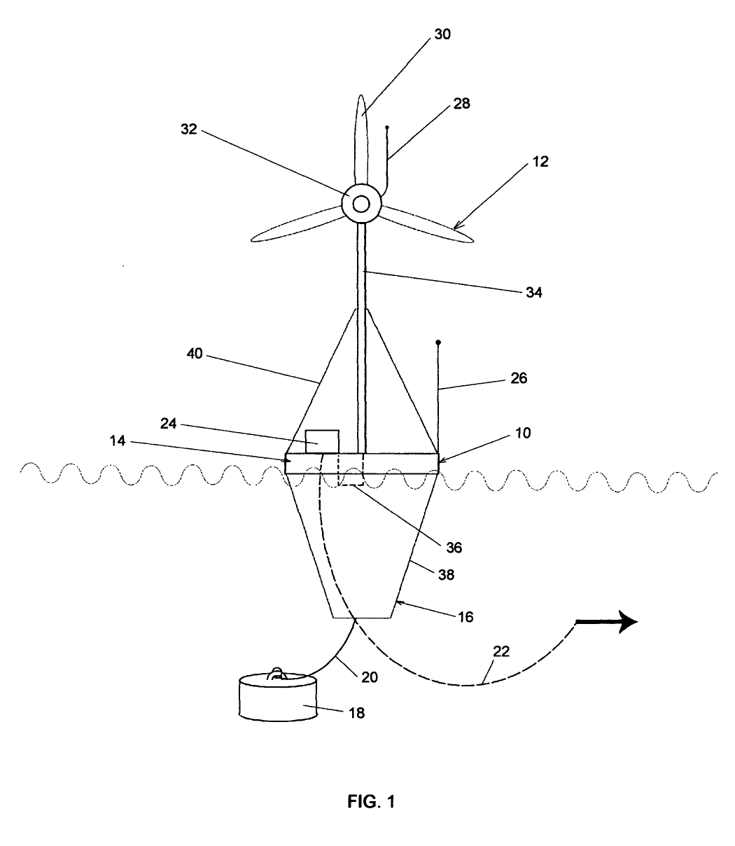

Turning now to FIG. 1, a generator platform 10 of the present invention is shown in a conceptual representation. The platform includes the turbine 12, the base 14, the keel 16 and the tether 18. The tether is connected to the keel by the tether cable 20.

Other components of the platform include the transmission cable 22, the system manager 24, the antenna 26, and the weather mast 28.

The turbine is generally comprised of the propellers 30, the generator 32 and the support 34. Exiting from the base of the turbine are the generator cables 36.

The turbine is mounted to the base, as will be discussed in more detail below, but is also secured by the turbine stays 40 which run from the mid-section of the support to the base. Additionally, extending below the base and integrally a part of it is the hull portion 38. The hull portion is distinguishable from the keel as will be explained in more detail below. The base in the preferred embodiment is shown as torus shaped, although it is understood that the base may be comprised of a sold surface (deck).

The System Manager.

One important feature of the present invention is the sophistication of the system manager. The system manager operates using computer hardware that would be compatibly selected to meet the anticipated demands for overall systems management, plus consideration would be made for redundancy, including provisions for duplicate hardware/software to operate in the event of a failure of the primary system. Inputs to the system manager come from the weather mast, from the antenna and from on-board systems. For instance, the weather mast is capable of collecting real time data on wind speed, apparent direction and real direction, temperature and any other data that might compatibly be collected in this fashion and which would be useful for operations.

The inputs are typically collected via sensors that convert readings to digitally recognized signals that are received by the computing portion of the system manager. The software used for management can thus determine the optimal position for the platform and/or the turbines relative to the wind flows. Also, the system manager can be provided with parameters so as to allow corrections and decisions to be made relative to platform conditions. Some of these parameters are compared with inputs from the antenna and from the power generation portion of the platform. Thus allowing the system manager to seek optimal performance conditions for the wind powered generator station.

The antenna is representative of the communications portion of the system manager and is used not only for telemetry between the organization who owns and/or manages the platform, but also for the collection of global positioning data (GPS), weather data for the region where the platform is located, as well as messaging and software enhancements.

Lastly, the on-board systems are inputted to the system manager and provide data on the level of power generation, real time indicators for turbine orientation, and any other on-board data that may be considered important for control and management purposes.

The system manager is able to determine the optimal parameters for collecting wind flows. This happens by way of controlling the orientation of the turbines, specifically the propellers and generator, to obtain maximum effect. By matching the wind director determined through the on-board weather data collected, these adjustments can be made in accordance with management software, which will preferentially increment the positioning of the turbines. Real-time correction is not necessary and can unduly wear on the turbine hardware by making constant position changes.

The system manager will also optimize power generation by using the pitch control on the propellers. This is useful when the system needs full pitch to take advantage of light wind conditions and then when the system may need to have the pitch corrected during periods of high wind conditions in order to avoid exceeding the operating parameters of the hardware.

The system manager monitors environmental weather conditions reported to it by external sources. The system software will make loner term decisions regarding the prevailing weather conditions. If and in the event the conditions warrant, this may include shutting the platform operations down such as would be the case in potential gale or hurricane type weather, thus preserving the equipment on the platform in a state of hibernation until the adverse weather event passes.

The complete set of decisions and adjustments that the system manager is capable of making is dependent upon the extent and scope of control that is desired over the platform functions. The primary function is the delivery of usable power from the platform and this is also subject to the system manager's control. The platform will typically include some capacitors for modulating the quantity of power that is being transmitted off the platform. The ideal is to deliver power in as consistent form as possible and the system manager has a role in this. The recipient of the transmitted power, whoever and wherever this may be, is assumed generally to be able to transform the power as may be required. This could include the use of inverters if the power is being transmitted in direct current form. In any event, the importance of the system manager in this respect is the ability to compatibly provide power in a form that is usable.

The system manager does have some communication responsibilities. It will generate real time and if desired, summary reports on the functioning of the platform. One aspect to the real time reporting is the confirmation of location which is obtained via the GPS inputs. One of the traditional downfalls with remote wind power generators is the level of control needed. This problem is exacerbated when you situate a wind farm on floating platforms which, if one should become free from its tether, could represent a hazard to shipping and not to mention the loss of the unit from service. The GPS portion of the system manager updates position so frequently that any dislocation can be determined and the system manager will commence messaging to give notice of the situation as well as initiate onboard reactions. The reactions would include the shutting down of turbine(s) and the preservation of settings and hardware. Once the message is received by the owner or operator of the unit, they can commence recovery of the platform by virtue of the fact they will continue to get updated reports as to its precise location. Where multiple platforms (stations) are deployed, each system manager can report real time location and conditions such that, where necessary, the stations can be prevented from colliding into each other (as will be discussed below, another embodiment of the present invention provides for self-contained propulsion systems which would be used in this circumstance), they can be arranged to minimize turbulence effects from one to the other, and power transmission can be synchronized across a number of such stations that might be sharing a common transmission cable. In essence, an aquatic wind farm is conceptualized that would be automated and independent.

The system manager is capable of responding to variances in conditions as well. If it is desired to elevate or moderate power production during peak times, or for a duration that corresponds to high or lower power requirements. The software will be able to accept these changes in requirements as remote messages, or if need be, the software can be modified remotely to take advantage of any changing situation and/or hardware.

Lastly, the system manager can track and detect maintenance requirements. If any change in functionality is observed by the system manager, a protocol for treating it as a maintenance item can be established. This can occur as a real-time condition or it can occur in the nature of preventative maintenance where the system manager tracks the “up time” associated with a given piece of hardware. For instance, if the preventative maintenance schedule for a turbine requires pre-set service after a number of hours of operation, the system manager can not only track the hours that the turbine is in actual use, but can place the predicted time for servicing on a schedule which can be used by the owner or operator of the system in conjunction the scheduling for all of the maintenance tasks across the organization.

The Turbine.

A large number of suppliers exist for wind turbines and it is not the intent within this application to attempt to delineate the type and availability of such units. The typical turbine comprises a number of propellers (or blades) that are engineered for the situation. Considerations for turbines propellers commence with the number of blades that are to be deployed. Stresses on the turbines require sophisticated design and control treatments, for instance, the fact that the turbine is meant to turn to orient towards the wind, creates a counter-reaction thanks to the gyroscopic tendencies of the rotating propellers which resist the rotating action. This reaction force is called precession and can result in early metal fatigue (and failure) of the propeller blades. In some instances precession is negated by altering the pitch of at least one of the propeller blades. The system manager can be used for this purpose.

In wind power generation, available wind power increases as the cube of the average wind speed. This means that the optimal placement of the turbine to capture as much wind as possible is beneficial. In the usual case, this means that the turbine should be at least higher than 30 meters above the surface of land (or water). In fact, many towers for land-based systems routinely exceed this height and some exceed 100 meters.

In the present invention, the tower height is an important consideration but given the fact that the platform is intended for use on the open water, wind flows are not as impeded as they might be on land. Nonetheless, there is still a ground effect that creates turbulence and reduces wind velocity. Tower height remains a consideration even if it is not as critical as it might be for land-based systems. In the present embodiment, height considerations are dependent, in part, upon the configuration of the base since the parameters of the top surface of the base will dictate to some extent, the anchoring potentials that are available for installation of the tower(s). The usage of the torus shape is believed to provide increased width to the base, thereby increasing the anchoring potentials available for tower installation, while still allowing the base to be fabricated in modular form so it can easily be transported to the desired location for deployment.

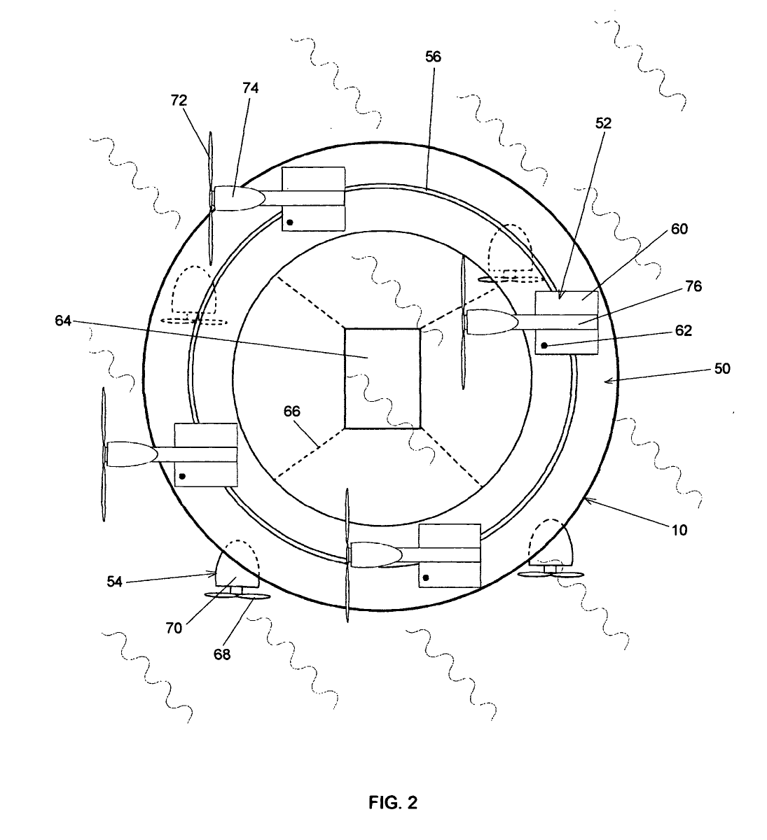

In the present embodiment there has been discussion concerning just one turbine although it is understood that any number of turbines may be deployed within the appropriate space and given the appropriate support. It needs to be kept in mind, however, that the spacing of turbines is a factor since each turbine disrupts airflows, creating a unique sort of turbulence. Some of this turbulence comes from the effects of the blades upon the airflows, but a good deal comes from the tower structure as well. Thus placement of turbines in staggered arrays is preferable to in-line arrangements, and similarly, considerations between one large turbine versus several smaller units may be driven by the logistics of locating the units appropriately. In fact, when air flows across the blades of the conventional wind turbine, the blades impart a rotation to the wind thus increasing the apparent wind speed. It is this rotation that contributes to additional turbulence, and also to additional stress conditions which disproportionately increase with increases in wind speed. This is the prime reason why some method for controlling turbine blade pitch in heavy weather conditions is necessary since it could very easily exceed the operating parameters of the turbine. There is an optimal arrangement for the placement of a number turbines in a given area which is a matter for one skilled in the art of turbine engineering, which will impact the arrangement for a given sized platform of the present invention. The size of the platform may be scaled accordingly, whether it is meant to provide for the installation of one or several turbines. The circular footprint of the platform (as is generally viewable in FIG. 2) contributes to the staggering of the turbines in a formation that retains the attributes of the present invention.

Another consideration that may not be so obvious is the material of construction for the turbine. Thanks in part to recent innovations in materials engineering, turbine components such as the propeller blades and housings can be made from low-weight materials such as carbon graphite. This is especially true when larger turbine units are being used since the desirable combination of strength and low-weight can be used to great advantage in constructing a turbine that is able to utilize more wind volume and thus be more efficient. Smaller units can be fabricated from other lightweight materials such as aluminum or fiberglass. Certainly the loading of the platform from a buoyancy perspective is another factor when deploying multiple turbines. This consideration is lessened somewhat by the design of another embodiment of the present invention which will be discussed in further detail below.

Servicing the turbines is an issue that bears some illumination. On the occasion that some maintenance is necessary for a given platform, a message can be sent to the system manager which will feather the blades on the turbine(s) and allow a service technician to access the platform. Even though the support height for turbine would normally keep the blades far out of the range of a person walking on the top of the platform, safe working practices would necessitate a procedure to stand down the turbine(s). It is contemplated that access to the turbine itself would be made by using tried techniques such as a bosun's chair or mechanical climbing tools.

The Stabilizing Portion.

As shown in FIG. 1, the keel is a projecting portion of the platform that extends downwardly. Conceptually, the keel may be constructed as a solid and watertight vessel as represented in the drawing or, as will be discussed below, it could have other configurations.

The function of the keel, however constructed, is to act as a counter-balance to the topside portion of the platform. As discussed above, the weight considerations for the turbines and related hardware is not an insignificant matter and this is also true with respect to the stability of the platform in the water. The keel has to function so as to keep the wind powered generator station in a substantially vertical or upright orientation.

The keel is the main component for the stabilizing portion of the platform. As the term suggests, the keel is a weighted part that is intended to lower the center of gravity of the platform as a whole. To accomplish this, a combination of actual weight, typically in the form of lead or steel, is placed at the lowest manageable point below the waterline of the platform. In the present embodiment, the weight or ballast (not shown) is located in the bottom portions of the hull, and in fact, could fill the hull if warranted. The hull in the present embodiment is a watertight vessel that may resemble a truncated cone shape. Other shapes for the hull can be readily conceived, the point being the ability to place the ballast as far below the platform as is feasible. Hulls of fiberglass, steel, or even concrete (Ferro cement) construction are known and would serve the purposes of the present embodiment.

In use, the weighted keel would keep the platform, and therefore the turbines and related hardware, in a substantially upright condition. There would be times incident to heavy winds and/or weather where the platform would be subject to being tossed around. The effect of the keel at that time would be to provide a constant bias to returning the platform to an upright condition. It is doubtful that the platform would be operating during such conditions since the wind speeds could likely exceed operating parameters. Nonetheless, the keel would still keep the platform from becoming submerged, thus preventing the dousing of the hardware, which would be made as weatherproof as possible.

The keel also performs a function during periods of lesser wind and weather conditions. The tendency exists for the tower or support for the turbines to exert a torque on the platform during operation. When this occurs at or near the upper limits of operation, the keel needs to be capable of counter-balancing this effect in order to maximize power generation. Thus the sizing of the keel and the distance of the placement of the weight or ballast does contribute to the ultimate efficiency of the unit as a whole.

The Tether.

The present embodiment includes a tether which is represented by the tether cable 20 extending down to the tether 18. This representation is intended to show the functional effect of having the platform tied off to some anchor or anchor point sufficiently robust to prevent the dislocation of the platform under anything but the most extreme conditions. The representation may be as simple as a cable tied to a submerged weight, or it may be a situation where a more engineered foundation and tie-off is provided which may be required depending on the platform size and the generally prevailing current and weather conditions at that location.

The tether portion of the present embodiment provides several functions, which is generally to secure the platform in a particular location, but this function serves to keep the platform located so maintenance and any other service functions can be provided, and to allow the transmission cable to remain connected to the platform and also to prevent the unit from wandering into shipping lanes where it could become a hazard. The tether cable in this embodiment is presented as a simple cable with strength sufficient to keep the platform tied off.

The Power Link.

In the present embodiment, the transmission cable 22 is the primary power link between the platform and the end use application. The power link, as the name implies, is the conduit for transmitting the output from the generator portion of the system to a point where it can be used, stored, transformed or distributed. The end use application therefore can be a grid, for instance, that is supplying a community of power consumers. It may also be a point use application such as a natural gas or oil platform.

The transmission cable is intended primarily for handling the output from the generator system, however, the cable may also provide an opportunity for other functions to “piggy-back” such as communications, data transfer and the like. In these instances, the transmission cable may actually comprise a bundle, with both power transmission capabilities and perhaps fiber optic or similar communication capabilities.

The transmission cable, or power link, has some natural restrictions. The distance between the platform of the present invention and the end use application will be limited by the feasibility of running the transmission cable there between. This is not so burdensome where the end use application is a resort island or a coastal community since the distance will likely be manageable. For longer distances, there is an alternate embodiment of the present invention that will be described in more detail below.

Alternate Platform.

One alternate embodiment of the present invention is shown in FIG. 2 which represents a platform that includes multiple turbines and a propulsion system for moving the platform. More specifically, the generator platform 10′ includes a base 50, turbines 52, drives 54, management bus 56, system management 60, a combined antenna and weather mast 62, a keel portion 64 and keel cables 66.

The representative drawing also shows the drives as including the drive propellers (or blades) 68, the drive motors 70. The generators 74, which in this case are four in number, are shown as being mounted on support(s) 76.

In this version of the invention, the usage of multiple turbines is indicated. This may, at times be preferred over the usage of a single turbine, however, efficiency in turbines increases with the size of the turbine. Thus it is generally true that deployment of a large, or a few large turbines would be preferential to the deployment of many smaller units. Notwithstanding this relationship, there will be other constraints on turbine selection where size is a secondary factor, i.e., where platform size is limited by design or by choice, or otherwise.

The present embodiment differs from the first in that it has a propulsion system. In this case, the electric motor drives, typically called “pods” in the industry, can draw off on-board battery storage and upon command, can power the platform and cause it to be “sailed” on a specific course. Typical of the pods are units that are manufactured by Alston, a British manufacturer that has supplied marine propulsion drives for cruise ships and other vessels. Their “Mermaid™” brand of pods cover a very broad range of capabilities and include the largest such units ever used. The pod housings are designed to be hydrodynamically optimized and contain the electric drive motor. The pod can be rotated through 360 degrees and integrate with drive and system controls for automated and semi-automated running.

In the present embodiment, the drives communicate with the system manager which will result in the drives being oriented to a specific heading and then powered so as to keep the platform in the desired location. The primary function of the drives in the present invention is not to motor the unit to a location, but to keep it in a specific position without the need for a tether arrangement. This advantage means that the platform of the present invention can be located without regard to the depth of a location and/or physical limits of the tether to be able to maintain the position of the platform. This could see the deployment of the platform in areas where strong currents may prevail or where water depths are very great.

The drives are controlled by the system manager which uses the management bus to upload and download information, data and commands to operational components of the platform. The management bus circumnavigates the platform and allows two-way pathways for communications to work. In this fashion, elements of the platform can be disengaged from the system without the whole system going down. This is a useful attribute when affecting repairs and the need to maintain some level of system control is still present. It would be possible to physically remove a component from the system and then restore it to operation while the component is taken away for repairs at a remote location. This minimizes downtime costs and allows some redundancy to be built into the system.

Another distinction in this embodiment as compared to the first, is the keel which, like the first version of the present invention, is located in a central position to the platform base but as far below as is feasible. In this instance, however, the keel is not built into the base integrally as was the case previously. The keel is actually suspended below the base by means of cables. This construction allows the keel placement to be far lower than would be the case for a similar weighted keel and hull arrangement. The advantage is that the effectiveness of the keel will be improved and the ability of the platform to withstand wind and wave impacts will be improved.

The center portion of the base is open to the water in this version of the present invention. There is no need to have a continuous deck which adds weight and costs to the platform. In addition, the circular base may be constructed from modular segments which can be prefabricated in mass and then brought to a site, floated into an area where the installation may be desired, then joined together to form the base as shown. This method makes it simpler to transport the platforms, using modest transport vessels as opposed to larger ships that would be needed to carry (and offload) much larger single-piece units. The keel is added after the base has been assembled and aside from the use of a crane or winch to lower the weighted portion, the need for sophisticated and prohibitively expensive equipment is obviated.

The present invention may be varied in ways that increase its utility. For instance, there may be some locations where the prevailing conditions prevent the usage of a transmission cable. In this case, a power link may be conceptually redefined in another way. The platforms can be modified to allow the power generated to be used in an on-platform hydrogen production unit. The usage of electrolytic action to release hydrogen from water is well known. It is contemplated, however, that the preferred location for units of the present invention will be in salt-water environments. This changes the chemistry for electrolysis since the salt chlorides will be given up as chlorine as the hydrogen gas is concurrently formed in the process. This type of system is known commercially and is used, on different scales, by many entities predominantly for the production chlorine (which is quickly reduced to sodium hypo chlorite) rather than the hydrogen gas. These applications desire the chlorine chemistry for disinfection purposes and include uses such as swimming pools, municipal sewer and water systems.

In the present invention, the hydrogen gas can be collected and the chlorine chemistry “wasted” back into the seawater without any real adverse effects. While this form of electrolysis may not attain the efficiencies of methods that use different water sources and which are optimized for hydrogen production, the fact is that the efficiency in this case is secondary to the conversion of the wind power to the hydrogen gas. In this manner, the “power link” in this embodiment is the hydrogen itself which can be stored on the platform and then offloaded to tenders that would make rounds. Given the fact that the system manager is independently watching over operations as a whole, the hydrogen production can continue without the need for human intervention for long periods of time and without the possibility of exhausting the chemical feed stocks (in the typical case, sea water). The only limitation on the system is the upper limits for the capacity of hydrogen storage.

Obviously when the hydrogen is transported by the tender to a collection site, it can be used in any number of ways since it is a very versatile fuel. Ironically one way that it might be used is to fuel a generator for producing electrical power and outputting it directly into the grid. Hence the conceptual connection between the hydrogen production as a power link in a manner that is not dissimilar to the previous embodiment with respect to the final result.

Similar situations can be envisioned where the platforms of the present invention could be used to transform wind power into other useful ways. For instance, desalinization of sea water would be analogous to the hydrogen generation scenario described above, with the difference coming from the fact that end product is not used for the purpose of delivering an energy result, but rather is used to produce fresh water for drinking or agricultural purposes.

These and other attributes and benefits of the present invention result from the ability to use the platforms as described herein. The teachings are therefore not meant to be limiting in any way but are intended to illustrate the variations of practice that may be reasonably foreseen.

1. A platform for a wind powered generator system comprising:
A base portion suitable for flotation of a wind powered generator station on a body of water at a location;
A stabilizing portion for maintaining said base portion in an upright orientation;
A control portion for automated management of the wind powered generator station where automated management independently responds to inputs monitored by the control portion, where such inputs include data relating to wind powered generator station operations, orientation and location;
A power generation portion for the conversion of wind power into electrical energy;
A tether portion for retaining said platform in a location;
A power link portion for the transport of the output of the power generation portion to another location.

2. A platform as in claim #1 where the tether is an anchor connected to the platform and capable of retaining the wind powered generator station in the location.

3. A platform as in claim #1, where the base portion further includes a surface for mounting said power generation portion thereon.

4. A platform as in claim #1, where the stabilizing portion comprises a keel that can compatibly retain the wind powered generator station in an upright orientation.

5. A platform as in claim #1, where the control portion comprises software and hardware.

6. A platform as in claim #1, where the power generation portion comprises at least one wind turbine for the generation of electrical energy.

7. A platform as in claim #1, where the power link portion further includes a hydrogen production portion for the conversion of electrical energy into hydrogen, and a hydrogen storage portion for the retention of produced hydrogen until it can be offloaded for transport to another location.

8. A platform as in claim #1, where the power link portion comprises a transmission cable for the transport of electrical energy produced by the power generation portion to another location.

9. (canceled)

10. (canceled)

11. (canceled)

12. (canceled)

13. (canceled)

14. (canceled)

15. (canceled)

16. A platform for a wind powered generator system comprising;
A base portion for flotation of a wind powered generator station on a body of water, where said base portion includes a surface for mounting a power generator portion thereon;
A tether portion for retaining the wind powered generator station at a location;
A stabilizing portion for maintaining the base portion in a desired orientation, where the stabilizing portion comprises a keel capable to retain the base portion in an upright condition;
A control portion for the automated management of the wind powered generator station, where automated management independently responds to inputs monitored by the control portion where such inputs include data relating to wind powered generator station operations, orientation, and location and where said control portion comprises software and hardware;
A power generation portion for the conversions of wind power into electrical energy, comprising at least one wind turbine;
A power link portion for transport of electrical energy to another location, comprising a transmission cable.

17. A platform as in claim #16, where the control portion further includes global positioning capability.

18. A platform as in claim #16, where the base portion is torus shaped.

19. A platform as in claim #16, where the keel is suspended below the base portion.

20. A platform for a wind powered generator system comprising:
A base portion for flotation of a wind powered generator station on a body of water, where said base portion includes a surface for mounting a power generator portion thereon;
A propulsion system for maintaining the wind powered generator station at a location;
A stabilizing portion for maintaining the base portion in a desired orientation, where the stabilizing portion comprises a keel capable to retain the base portion in an upright condition;
A control portion for the automated management of the wind powered generator station, where automated management independently responds to inputs monitored by the control portion where such inputs include data relating to wind powered generator station operations, orientation and location and where said control portion comprises software and hardware;
A power generation portion for the conversions of wind power into electrical energy, comprising at least one wind turbine;
A power link portion for transport of electrical energy to another location, comprising a transmission cable.

21. A platform as in claim #20, where the control portion further includes global positioning capability.

22. A platform as in claim #20, where the base portion is torus shaped.

23. A platform as in claim #20, where the keel is suspended below the base portion.

24. A platform as in claim 20, where the propulsion system comprises at least one pod drive.

25. A wind powered generation process, the method for installation, operation and management comprising:
Transporting one or more wind powered generator stations to individually specified locations on a body of water;
Placing one or more wind powered generator stations at each of the location;
Enabling each wind generator station to commence automated collection and conversion of wind power into electrical energy using;
a) a base portion
b) a stabilizing portion
c) a control portion for automated management of the wind powered generator station where the automated management independently responds to inputs monitored by the control portion, where such inputs include data relating to wind powered generator station operations, orientation, and location, and
d) a power generation portion;
Transporting the output from each wind powered generation station to another location.

26. A process as in claim #25, where the step for transporting the output from each wind powered generator station further includes:
Converting the generated electrical power into hydrogen;
Storing the hydrogen;
Offloading the hydrogen on a periodic basis;
Transporting the hydrogen to another location.

27. A process as in claim #25, where the automated management includes input from a GPS source for management of location

28. A platform for a wind powered generator system comprising:
A base portion suitable for the flotation of a wind powered generator station on a body of water at a location;
A stabilizing portion for maintaining the wind powered generator station in a desired orientation;
A control portion for automated management of the wind powered generator station where automated management independently responds to inputs monitored by the control portion, where such inputs include data relating to wind powered generator station operations, orientation, and location, where the input for the management of location is a GPS source;
A power generation portion for the conversion of wind power into electrical energy;
A power link portion for the transport of the output of the wind powered generator station to another location;
A propulsion system controlled by the control portion for maintaining a wind powered generator station at the location.

29. A platform as in claim #28, where the base portion further includes a surface for mounting said power generation portion thereon.

30. A platform as in claim #28, where the stabilizing portion comprises a keel sufficient to maintain the wind powered generator station in an upright orientation.

31. A platform as in claim #9, where the control portion comprises software and hardware for management of the wind powered generator station.

32. A platform as in claim #28, where the power generation portion comprises at least one wind turbine for the generation of electrical energy.

33. A platform as in claim #28, where the power link portion further includes a hydrogen production portion for the conversion of the generated electrical energy into hydrogen, and a hydrogen storage portion for the retention of the produced hydrogen until it can be offloaded for transport to another location.

34. A platform as in claim #28, where the power link portion comprises a transmission cable for the transport of the electrical energy produced by the wind powered generator station to another location.

35. A platform as in claim #28, where more than one wind powered generator system is deployed at a location and where the control portion of each such wind powered generator system maintains its location in coordination with the locations assigned to each of every other wind powered generator system.

36. A platform as in claim #28, where part of the automated management is dependent on inputs received from a remote source.
